(19) United States
(12) Patent Application Publication
(10) Pub. No.: US 2008/0095456 A1
(43) Pub. Date: Apr. 24, 2008

(54) Adaptive Classification System and Method for Mixed Graphic and Video Sequences

(75) Inventors: Xuejun Hu, Arlington, TX (US); Lilla L. Boroczky, Mount Kisco, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,132

(22) PCT Filed: Aug. 10, 2005
(86) PCT No.: PCT/IB05/52657

§ 371 Date: Feb. 2, 2007

Related U.S. Application Data
(60) Provisional application No. 60/601,446, filed on Aug. 13, 2004.

(51) Int. Cl. G06K 9/36

(52) U.S. Cl. 382/250

(57) ABSTRACT

A system, method and program product for classifying mixed graphic and video signals. A system is provided comprising: a system for receiving blocks of pixel data; and a classification system for evaluating an inputted block of pixel data to determine if the inputted block is a pure graphic block, a flat area block, a sharp transition block or a normal video block.

The present invention relates generally to systems for processing mixed graphic and video sequences, and more particularly relates to an adaptive classification system and method for mixed graphic and video sequences.

Current electronics products employ more and more advanced digital signal and image processing techniques, which can be very demanding for memory size and communication bandwidth between units of a system. In practice, reduction of memory size to meet implementation cost requirements or reduction of the communication bandwidth to meet the system requirements is often needed. Accordingly, signal processing techniques, such as compression, must be utilized to meet these challenges.

Such challenges are made more acute by systems that process mixed signals, e.g., video and graphics. The processing of a mixed signal can be a complex problem, because the source has varying signal statistics. Graphic data and video data need to be distinguished to apply different video processing due to their different characteristics. For example, standard video compression techniques often introduce “blurring” and “rippling” artifacts in sharp-edge occasions. These artifacts appear frequently and are much more annoying in graphics. Accordingly, it is preferable that certain types of processing be applied to one type of signal, e.g., video, and not to others, e.g., graphics.

In order to implement such a system, signals must be effectively classified. Most of the current classification algorithms distinguish between video and graphic information and index the corresponding position within a frame. Some also exploit the correlation between consecutive frames. Other block based segmentation methods are usually performed on 2D blocks. Unfortunately, these techniques may incur significant computational costs, which is counterproductive to the goal of reducing computational overhead. Accordingly, a need exists for a system and method of classifying mixed video and graphic signals with acceptable computational complexity and performance.

The present invention addresses the above-mentioned problems, as well as others, by providing a system and method for classifying mixed video and graphic signals. The invention provides a one-dimensional (1D) block-based classification algorithm that divides RGB data blocks into four categories. After the blocks are classified, different video processing techniques can be employed on each block as needed. Compared to existing classification methods, the present algorithm is simple, requiring a very small segmentation buffer, is adaptive to the local scene content and suitable for real-time operation. These features make the proposed method especially suitable for embedded compression system.

In a first aspect, the invention provides a system for classifying mixed graphic and video signals, comprising: a system for receiving blocks of pixel data; and a classification system for evaluating an inputted block of pixel data to determine if the inputted block is a pure graphic block, a flat area block, a sharp transition block or a normal video block.

In a second aspect, the invention provides a method for classifying mixed graphic and video signals, comprising: inputting a block of pixel data; and evaluating the inputted block of pixel data to classify the inputted block as one of a pure graphic block, a flat area block, a sharp transition block and a normal video block.

In a third aspect, the invention provides a program product stored on a recordable medium for classifying mixed graphic and video signals, comprising: means for receiving a block of pixel data; first classifying means for classifying the inputted block as a pure graphic block if the pixels in the inputted block are comprised of not more than two values; second classifying means for performing a Hadamard transformation on the inputted block and comparing a sum of the absolute values of a subset of the Hadamard coefficients to a threshold in order to determine if the inputted block is a flat area block; and third classifying means for classifying the inputted block as a sharp transition block if:
consecutive pixels in the inputted block have identical values; and

$${\sum }_{i = 0}^{7} \vert ( {x}_{i} - \overline{x} ) \vert > threshold ,$$

where xᵢ is pixel value, and x̅ is the mean value of the block.

These and other features of this invention will be more readily understood from the following detailed description of the various aspects of the invention taken in conjunction with the accompanying drawings in which:

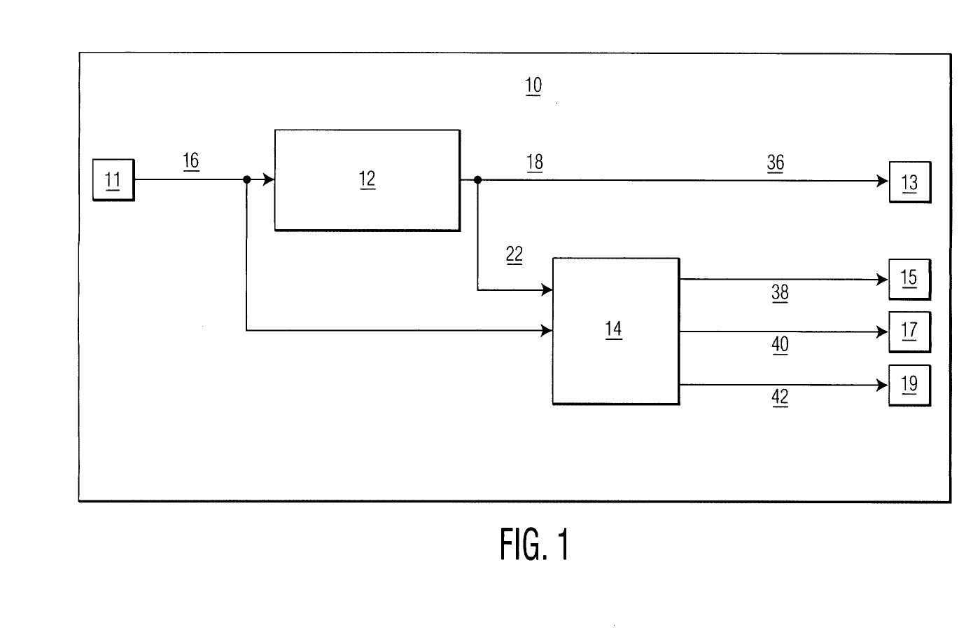

FIG. 1 depicts a video processing system in accordance with the present invention.

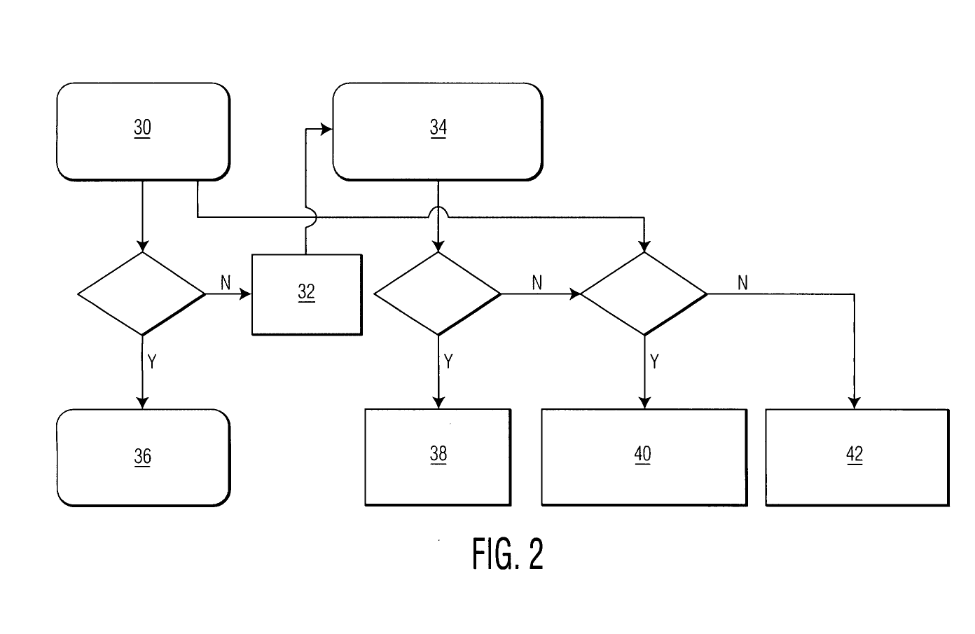

FIG. 2 depicts a classification methodology in accordance with the present invention.

Referring now to FIG. 1, a video processing system 10 is shown that includes a classification system that processes a one-dimensional (1D) pixel block generated from a source 11, and classifies the block into one of four categories. Once categorized, the block can be further processed by post-processing systems 13, 15, 17 or 19. In general, the pixel block comprises pixel data from a mixed video and graphic signal 16. In an illustrative embodiment, the post-processing systems 13, 15, 17, 19 may comprise compression or encoder systems suitable for processing the categorized pixel block. It should be noted that although not shown, video processing system 10 may comprise all of the features, components and functions, typically found in a video processing device (e.g., memory, CPU, bus, I/O, display, etc.).

Whenever the classification system receives a pixel block from a mixed video and graphic signal 16, it classifies the block as a pure graphic block 36, a flat area block 38, a sharp transition block 40 or a normal video block 42. While the present invention is described with respect to classifying a 1×8 RGB pixel block, it should be understood that the invention could be applied to blocks of different sizes (e.g., 1×10, 2×8, etc.). It should also be noted that the general concept of the invention could be extended to color spaces other than RGB.

The initial classification system 12 first divides the data into one of two categories: either a pure graphic area 18 or a general video area 22. Secondary classification system 14 further refines the general video area 22 into one of three specially featured blocks, namely, a flat area block 38, a sharp transition block 40 or a normal video block 42.

FIG. 2 depicts an illustrative classification methodology in more detail. Initially, a 1×8 pixel block 30 is examined to determine if the block meets a first condition (condition A, described below). If pixel block 30 meets condition A, the block is categorized as a pure graphic block 36. If pixel block 30 does not meet condition A, the pixel block 30 is transformed, e.g., with a Hadamard transformation 32, to generate a 1×8 coefficient block 34 containing a set of transform coefficients, and the transformed coefficient block 34 is examined to see if it meets condition B (described below). If condition B is met, pixel block 30 is categorized as a flat area block 38. If condition B is not met, then pixel block 30 is examined to see if it meets condition C (described below). If pixel block 30 meets condition C, pixel block 30 is categorized as a sharp transition block 40. If it does not meet condition C, pixel block 30 is categorized as a normal video block 42.

Condition A seeks to distinguish graphic data from video data. Conventional transform based video compression often introduces distortions like “edge blurring” and color fluctuations of background areas that are supposed to be completely “flat.” Such compression techniques are intolerable in clean and neat graphic images. Thus, graphic data cannot be subjected to video compression and thus needs to be distinguished from video data. Pure graphic blocks contain runs of pixels with identical values and the transitions between the different values are generally at right angle. Based on this feature analysis, the classification criteria for condition A is as follows:

if all of pixels in one block belong to only two values, i.e., a background value and text value, or if all of the pixels in one block have the identical pixel value,

then the pixel block is classified as “pure graphic block.”

For example, if Blk₁ has pixels with the values [128 128 128 128 127 127 128 128], then this block is classified as a pure graphic block 36 (and could more specifically be identified as a “bi-value pure graphic block”). Similarly, if Blk₂ has pixels with the values [255 255 255 255 255 255 255 255], then this block is also classified as a pure graphic block 36 (and more specifically could be identified as a “mono-value pure graphic block”).

If the inputted 1×8 pixel block does not meet condition A, then a test is made to determine if the block 30 is a flat area block 38. Coding artifacts and “temporal jitter” are much more obvious and annoying in flat areas. Accordingly, it is desirable to identify flat blocks and process them accordingly, e.g., with a lossless compression. To determine if the pixel block 30 is a flat area block 38, the block 30 is first subjected to a Hadamard transform 32. Hadamard transforms are known in the art of signal and image processing, and are therefore not described in detail.

A Hadamard transform matrix employs row ordering in terms of rate of change of zero crossings. Transform coefficients are then produced in order of rapidity of change in the data vector, corresponding loosely to an intuitive notion of frequency. The activity measure that is derived from the AC energy of the transformed block determines whether condition B is met. For a 1×8 block, AC energy can be computed as the sum of squared AC spectral coefficients:

$${A}_{s} = {\sum }_{i = 1}^{7} {C}_{i}^{2} .$$

Considering computational simplicity, the activity is determined using absolute values as follows:

$$A = {\sum }_{i = 1}^{7} \vert {C}_{i} \vert < {threshold}_{1} ,$$

as the approximation of Aₛ.

Flat areas contain no texture and no edges; therefore their AC energy is low. In addition, the energy contained in high frequency components is also low. According to the above block feature analysis, the classification criteria for condition B can therefore be defined as:
If

$${\sum }_{i = 4}^{7} \vert {C}_{i} \vert < {threshold}_{1} ,$$

where Cᵢ, (for i=4 . . . 7) are a subset of the coefficients of a Hadamard-transformed block,
then the block is classified as “flat area block.”
   In one illustrative embodiment, the threshold₁ can empirically be set to 12. In case the compression requires more strict classification to achieve better picture quality and compression efficiency, the following alternative criterion may be adopted, which examines a sum of the absolute values of a first subset of coefficients (i=1 . . . 7) and a second subset of coefficients (i=4 . . . 7):
If

$${A}_{S} = {\sum }_{i = 1}^{7} \vert {C}_{i} \vert < {threshold}_{2} and {A}_{h} = {\sum }_{i = 4}^{7} \vert {C}_{i} \vert < {threshold}_{3} ,$$

then the block is classified as “flat area block.”
   The thresholds may be empirically determined. For example, threshold₂=40, and threshold₃=20. Obviously, the choice of threshold values can vary without departing from the scope of the invention.

Consider the following example where Blk₃ in the spatial domain has pixel values [95 95 95 94 93 91 90 91]. After the Hadamard transform, the coefficients block in the transform domain is [744 14 −2 4 2 4 0 2]. Applying the second more strict criterion, this block would be classified as flat block because Aₛ=(14+2+4+2+4+0+2)=28<40 and Aₕ=(2+4+0+2)=8<20.

If neither condition A nor condition B was met, then the 1×8 pixel block 30 would be tested against condition C. In graphic images, special font effects such as shadowing, embossing or engraving are frequently applied, leading to still sharp, but not right angle, transitions from text to background or vice versa. Conventional transform-based video compression often introduces rippling artifacts along the edge and fluctuation of pixel values in the background that were constant before transform. Because this can be more annoying in graphic images than in video images, distinguishing these kinds of blocks from graphic areas is necessary.

This kind of block contains sharp transitions between relatively flat areas. They have some similar properties to the pure graphic blocks, such as containing runs of identical values, i.e., the dynamic range between the maximum and minimum values is large. However, as noted, the transitions are not at right angles, but are still very sharp. Based on the above analysis, the distinction can be made by examining the following conditions:

1. Consecutive pixels in a block have identical values

2.

$${\sum }_{i = 0}^{7} \vert ( {x}_{i} - \overline{x} ) \vert > {threshold}_{4} ,$$

where xᵢ is pixel value, and x̅ is the mean value of is the block, and, e.g., threshold₄=110.

Provided both (1) and (2) are satisfied, the block is classified as a “sharp transition block” 40. Note that some isolated blocks in a video frame could be identified as a sharp transition block 40. This just achieves a small picture quality improvement at the price of a large compression efficiency reduction. To eliminate or reduce the possibility that some blocks within the pure video frames are identified as sharp transition blocks, a block is only classified as having a sharp transition if the previous block is pure graphic block 36 or a sharp transition block 40.

Blocks that do not satisfy the above conditions are classified as normal video blocks 42.

Note that while the embodiments described herein utilize a Hadamard transformation 32 to generate a set of frequency-based transform coefficients, other transformations, including discrete cosine transformations (DCT), etc., may be utilized and fall within the scope of this invention. Note also that if a DCT or other transformation were utilized, then the thresholds established in Condition B described above would have to be appropriately adapted.

It is understood that the systems, functions, mechanisms, methods, engines and modules described herein can be implemented in hardware, software, or a combination of hardware and software. They may be implemented by any type of computer system or other apparatus adapted for carrying out the methods described herein. A typical combination of hardware and software could be a general-purpose computer system with a computer program that, when loaded and executed, controls the computer system such that it carries out the methods described herein. Alternatively, a specific use computer, containing specialized hardware for carrying out one or more of the functional tasks of the invention could be utilized. In a further embodiment, part of all of the invention could be implemented in a distributed manner, e.g., over a network such as the Internet.

The present invention can also be embedded in a computer program product, which comprises all the features enabling the implementation of the methods and functions described herein, and which—when loaded in a computer system—is able to carry out these methods and functions. Terms such as computer program, software program, program, program product, software, etc., in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

1. A system for classifying mixed graphic and video signals, comprising:
a system for receiving blocks of pixel data; and
a classification system for evaluating an inputted block of pixel data to determine if the inputted block is a pure graphic block, a flat area block, a sharp transition block or a normal video block.

2. The system of claim 1, wherein the block of pixel data comprises a 1×8 pixel block.

3. The system of claim 1, wherein the classification system includes a first subsystem that classifies the inputted block as a pure graphic block if the pixels in the inputted block are comprised of not more than two values.

4. The system of claim 3, wherein the classification system includes a second subsystem that performs a transformation on the inputted block to generate a set of transform coefficients, and compares a sum of the absolute values of a subset of the transform coefficients to a threshold in order to determine if the inputted block is a flat area block.

5. The system of claim 4, wherein the second subsystem further compares a sum of the absolute values of a second subset of the transform coefficients to a second threshold in order to determine if the inputted block is a flat area block.

6. The system of claim 4, wherein the classification system includes a third subsystem that classifies the inputted block as a sharp transition block if:
consecutive pixels in the inputted block have identical values; and
$${\sum }_{i = 0}^{7} \vert ( {x}_{i} - \overline{x} ) \vert > threshold ,$$
where x₁ is pixel value, and x̅ is the mean value of the block.

7. The system of claim 6, wherein the third subsystem further tests to determine if a previous block was a pure graphic block or a sharp transition block in order to determine if the inputted block is a sharp transition block.

8. The system of claim 6, wherein the classification system classifies the inputted block as a normal video block if the block is not classified as a pure graphic block, a flat area block or a sharp transition block.

9. The system of claim 4, wherein the transformation is selected from the group consisting of: a Hadamard transformation and a discrete cosine transformation.

10. A method for classifying mixed graphic and video signals, comprising:
inputting a block of pixel data; and
evaluating the inputted block of pixel data to classify the inputted block as one of a pure graphic block, a flat area block, a sharp transition block and a normal video block.

11. The method of claim 10, wherein the evaluating step includes the step of classifying the inputted block as a pure graphic block if the pixels in the inputted block are comprised of not more than two values.

12. The method of claim 11, wherein if the inputted block is not a pure graphic block, then the evaluating step implements the step performing a transformation on the inputted block and comparing a sum of the absolute values of a subset of transform coefficients to a threshold in order to determine if the inputted block is a flat area block.

13. The method of claim 12, wherein the evaluating step further compares a sum of the absolute values of a second subset of the transform coefficients to a second threshold in order to determine if the inputted block is a flat area block.

14. The method of claim 12, wherein if the inputted block is not a pure graphic block or a flat area block, the evaluation step classifies the inputted block as a sharp transition block if:
consecutive pixels in the inputted block have identical values; and
$${\sum }_{i = 0}^{7} \vert ( {x}_{i} - \overline{x} ) \vert > threshold ,$$
where xᵢ is pixel value, and x̅ is the mean value of the block.

15. The method of claim 14, wherein the evaluating step further determines if a previous block was a pure graphic block or a sharp transition block in order to determine if the inputted block is a sharp transition block.

16. The method of claim 14, wherein if the inputted block is not a pure graphic block, a flat area block, or a sharp transition block, then the evaluation step classifies the inputted block as a normal video block.

17. The method of claim 12, wherein the transformation is selected from the group consisting of: a Hadamard transformation and a discrete cosine transformation.

18. A program product stored on a recordable medium for classifying mixed graphic and video signals, comprising:
means for receiving a block of pixel data;
first classifying means for classifying the inputted block as a pure graphic block if the pixels in the inputted block are comprised of not more than two values;
second classifying means for performing a Hadamard transformation on the inputted block and comparing a sum of the absolute values of a subset of the Hadamard coefficients to a threshold in order to determine if the inputted block is a flat area block; and
third classifying means for classifying the inputted block as a sharp transition block if:
consecutive pixels in the inputted block have identical values; and
$${\sum }_{i = 0}^{7} \vert ( {x}_{i} - \overline{x} ) \vert > threshold ,$$
where xᵢ is pixel value, and x̅ is the mean value of the block.

19. The program product of claim 18, wherein the second classifying means further compares a sum of the absolute values of a second subset of the Hadamard coefficients to a second threshold in order to determine if the inputted block is a flat area block.

20. The program product of claim 18, wherein the third classifying means further determines if a previous block was a pure graphic block or a sharp transition block in order to determine if the inputted block is a sharp transition block.

21. The program product of claim 18, further comprising means for classifying the inputted block as a normal video block if the inputted block is not a pure graphic block, a flat area block, or a sharp transition block.

22. The program product of claim 18, wherein the inputted block comprises a 1×8 block of pixel data.
